(19) United States
(12) Patent Application Publication
(10) Pub. No.: US 2002/0059630 A1
(43) Pub. Date: May 16, 2002

(54) Relating to a broadcast network

(76) Inventors: Juha Salo, Littoinen (FI); Janne Aaltonen, Turku (FI); Pekka Talmola, Turku (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/893,421

(22) Filed: Jun. 29, 2001

(30) Foreign Application Priority Data
Jun. 30, 2000 (GB) 0016240.4

(51) Int. Cl. H04N 7/173

(52) U.S. Cl. 725/108

(57) ABSTRACT

A digital broadcast network (1) operating in a hierarchical mode is described. The network (1) includes means (35) for classifying the data types making up the content to be broadcast. In accordance with the classification, the network (1) transmits the data types in an appropriate mode. In addition, there is described a method of defining a set of profiles in accordance with which content of a particular data type is assigned to a particular mode for transmission.

### BACKGROUND OF THE INVENTION

The present invention relates to the delivery of content over a broadband broadcast network, particularly although not exclusively a network having hierarchical transmission modes.

Broadband broadcast networks are known in which video and audio data are transmitted to a users equipped with suitable receivers. One such well known broadband network is the terrestrial Digital Video Broadcasting (DVB-T) system found in Europe and elsewhere where the video and audio data comprises a plurality of channels allowing the user to select from a range of content. It has been proposed to utilise such networks not only for the transmission of video and audio data but also for the delivery of more general data types including more general data traffic.

The delivery of more general data types such as IP data differs significantly from video and audio data. In the latter case, there is not the same requirement for error-free delivery of content by which, in this case, is meant the video and audio data which together forms a television broadcast. Consequently, there is no need and thus no mechanism to request re-transmission of faulty data. However, in the case of other types of content such as IP data, it is vital that packets are not lost or dropped.

The requirement for reliable delivery of content, particularly IP data, is all the more evident in the situation where a mobile terminal is being used to receive data. The less than optimum transmission conditions which can prevail in the case of a mobile terminal further exacerbate the difficulty of achieving reliable delivery of content.

### SUMMARY OF THE INVENTION

According to one aspect of the present invention, there is provided a head end device for use in a hierarchical network, the device comprising a classifier connectable to a source of content and operable to place the content into at least one of a plurality of hierarchical data streams corresponding to a particular class of content.

By placing the content into an appropriate stream on the basis of its class, one then is able to optimise the transmission resources of the broadcast network. As a result, the traffic load on the network can be reduced. Firstly, because the amount of data packets that are lost or dropped is reduced and secondly because there is a corresponding reduction in requests for re-transmission of those dropped or lost packets.

The content may be provided in the form of a data stream made up of data elements. Preferably, a splitter is connected to the output of the classifier wherein the classifier identifies the data type of each element of the stream and inserts a marker into said stream indicative of a priority assigned to the element. The splitter may then place each data element, in accordance with the marker, into a corresponding hierarchical transport stream for subsequent transmission by the network.

Preferably, the device includes a connection to a look-up table. The look up table advantageously comprises a set of profiles, each of which includes at least one definition of a priority for a particular data type. The choice of a particular profile is determined by the network. Thus the network may generate or allow the creation of a profile for a particular user based on the terminal type, level of service and the like. It will be recognised that the selection of content for delivery to a user may result from a push, that is at the request of a party other than the recipient of the content. The push originator might be an advertiser or other service provider for example. Otherwise, the content may be delivered to the recipient at his own request. In which case the request may be sent to the network over a return channel. The return channel might take the form of a dial-up modem connection over a public switched telephone network (PSTN). Alternatively, the request may be delivered over a mobile network such as General Packet Radio Service (GPRS) or a third generation network (3G).

According to another aspect of the invention, there is provided a method of transmitting content in a hierarchical network comprising classifying content received for transmission and placing the content into at least one of a plurality of hierarchical data streams corresponding to the classification of the content.

Again, in order to provide flexibility in the operation of the network, the method may include the establishment of a set of profiles, each of which includes at least one definition of a priority for a particular classification or data type. The selection of a particular profile is preferably under network control and may include profiles based on the type of user equipment such as a mobile terminal, PDA, or the like for example.

According to a still further aspect of the invention, there is provided a system for delivering content over a hierarchical network, comprising a source of content deliverable to a network, the network including head end equipment operable to place content into at least one of a plurality of selected hierarchical data streams for transmission by a transmitter, and a terminal operable to receive the data stream, wherein the head-end equipment classifies the content and in accordance with the classification places it into a corresponding hierarchical data stream.

Preferably, the terminal includes a return channel. This channel, which is connected over any suitable network such as a public switched telephone network (PSTN), public land mobile network (PLMN), or the Internet permits a user of the network to select content for delivery over the hierarchical network.

### BRIEF DESCRIPTION OF THE DRAWINGS

In order to aid in understanding the present invention, a particular embodiment thereof will now be described by way of example and with reference to the accompanying drawings, in which:

FIG. 1 is a diagrammatic view of a digital broadcast network according to an embodiment of the present invention;

FIG. 2 is a constellation diagram useful in understanding the principle of hierarchical transmission;

FIG. 3 is schematic view illustrative of the method according to the network of FIG. 1;

FIG. 4 is a table for use in accordance with the method of FIG. 3.

### DETAILED DESCRIPTION OF THE INVENTION

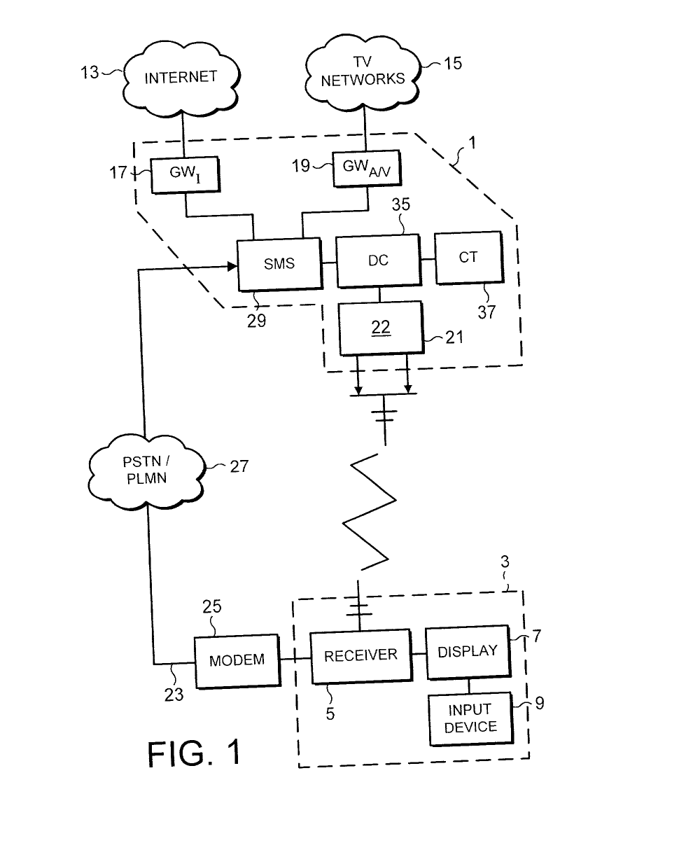

Referring to FIG. 1, this shows a terrestrial digital video broadcast (DVB-T) network 1. A user equipped with a suitable terminal 3 incorporating a receiver 5, display 7 and user interface 9, can receive data broadcast by the digital video broadcast network 1 from a transmitter 11 forming part of the digital video broadcast network 1. The content broadcast by the transmitter 11 is derived from a variety of sources 13,15 via gateways 17,19 and may respectively include Internet Protocol (IP) and Television content.

Before transmission, the content received from each source 13,15 is processed in head-end equipment 21. The content, can of course, be any form of data such as text, images, audio for example. As is well known in the art, the head end equipment places the data into MPEG-based data containers.

To cater for the delivery of data to a particular terminal or group of terminals, the containers may also hold address information which can be identified and read by a conditional access component in the terminal to determine whether the data is intended for that terminal. The network 1 also provides the facility for suitably equipped terminals to interact with the network. By suitably equipped terminal is meant a terminal having a return channel for providing network interactivity as exemplified in the case of DVB by a number of specifications published by the Digital Video Broadcasting Office and also the European Telecommunications Standards Institute (ETSI) including the following: DVB-NIP Network Independent Protocols for DVB Interactive Services ETS 300 802 (V1: 11/97), Guidelines for the use of the Network Independent Protocols for DVB Interactive Services TR 101 194 (V1.1.1: 06/97), DVB-RCP DVB interaction channel through the Public Switched Telecommunications System (PSTN)/Integrated Services Digital Network (ISDN) ETS 300 801 (V1: 08/97), DVB-RCG Interaction channel through the Global System for Mobile communications (GSM) EN 301 195 (V1.1.1: 02/99).

Thus, a user may request the delivery of a computer file from the network to her terminal. Such interactive functionality requires a return channel 23 from the terminal 3 to the DVB-T network 1 and a conditional access component in the terminal 3. The return channel 23 can be provided in the from of a dial-up connection using a modem 25 connected to the terminal 3 which establishes a connection over a telecommunications network 27 to a subscriber management system (SMS) 29 of the DVB-T network 1. The subscriber management system 29 has connections to both the gateways 17,19 and the transmitter head-end equipment 21. It is thus possible for the user to issue requests for specific content via the user interface 9 of the terminal 3. The request is received by the SMS 29 which obtains the content from the relevant gateway 17,19 and passes it to the transmitter head-end for placing into data containers for onward transmission. It should be noted that the request from the user might include content which is not presently being transmitted by the network 1. To ensure that the user only receives the requested content, the data is broadcast with an identifier which the conditional access component in the terminal 3 recognises as being intended for delivery to the user. In the event that the content is received by another terminal, the conditional access component of that terminal will prevent delivery of the content.

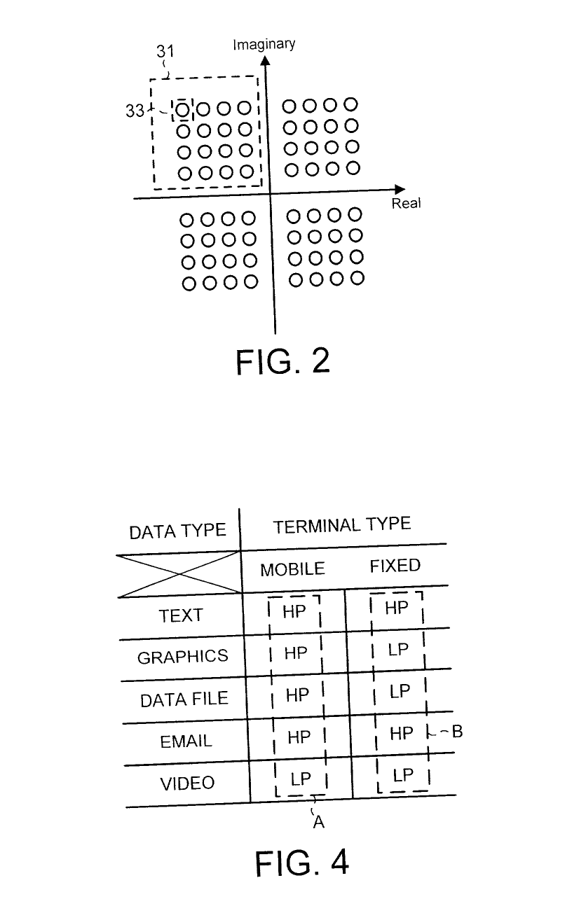

Turning to FIG. 2, this illustrates the principle of hierarchical modulation which is specified as an option in the DVB-T standard, for example. In DVB-T data for transmission is placed into data containers that are encoded as an MPEG-2 bit stream. This stream may then be split into two parts, a High Priority (HP) stream and a Low Priority (LP) stream, both of which are transmitted simultaneously. A bit sequence of the data which modulates the HP stream is used to select a quadrant 31 of the constellation diagram whereas for the LP stream a bit sequence of the data which modulates the stream selects a particular constellation point 33. The result is that the HP stream is more robust as a receiver can more easily identify a quadrant over a particular constellation point. However, the bit rate of the HP stream will be less than that of the LP stream. Thus, the LP stream can be utilised by the receiver where the C/N ratio is such as to allow the receiver to detect not only the quadrant but also a particular constellation point.

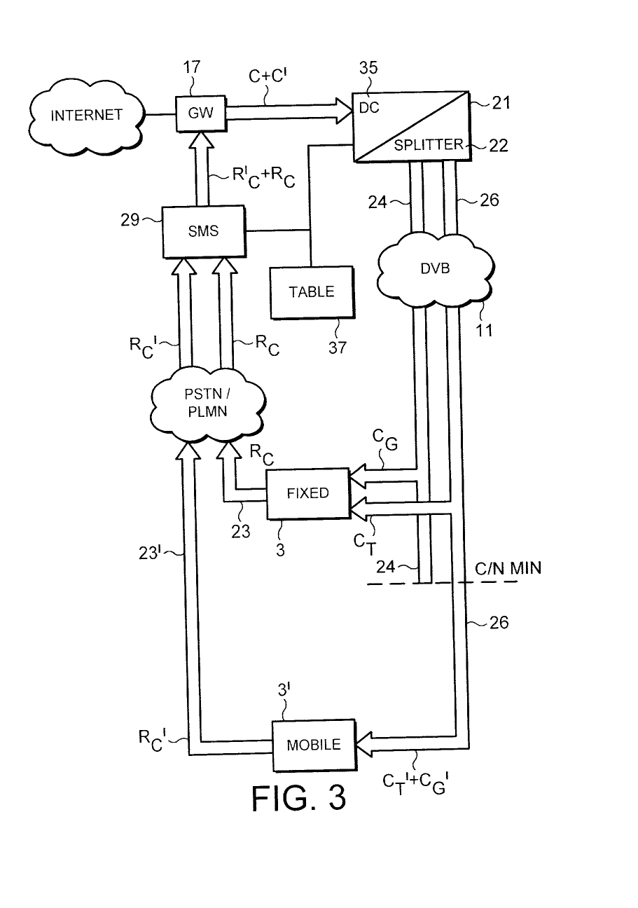

FIG. 3, shows schematically how, in the present embodiment, the HP and LP streams are used to deliver content to two users each having a different type of terminal. The first user is equipped with a mobile terminal 3′ and is located further from the transmitter 11 than the second user who is equipped with a fixed terminal 3. The chain line marked C/Nₘᵢₙ represents the maximum range from the transmitter 11 that a LP signal may extend whilst the C/N ratio remains above that necessary for its reception by a terminal.

In the situation illustrated in FIG. 3, each user has requested via her respective return channel 23′,23 a specific item of content R_{C}′,R_{C.} In this case, each user has requested a webpage made up of textual and graphical material. The request R_{C}′,R_{C} from each user is received by the SMS 29 and identified as being a request for Internet content. The SMS 29 then passes the request to the appropriate gateway, in this case the Internet gateway 17. This gateway 17 processes the request R_{C}′,R_{C} and retrieves the requested content C,C′ from the Internet. The content C′,C, which, as has already been explained, is made up of textual and graphical elements is returned to the SMS 29 which passes the content together with data identifying the user to a data classifier 35. The data classifier 35 identifies the elements of the content C′,C by analysing the data structure e.g. by identifying the file extension of each element. Once the elements of the content C′,C have been identified, the classifier 35, using the user data attached by the SMS 29, retrieves a user profile (FIG. 4) from the SMS 29 corresponding to the user who has made the request for the content C′.C. Using this profile, the classifier 35 is able to assign a priority to each element of the content it has identified which is then placed with the respective content. Optionally, the classifier 35 may have access to a further table 37 of priorities assigned to specific content which may override or supplement those set out in the user profile (FIG. 4). In this way it is possible for the classifier 35 to assign data a particular priority based on a number of criteria including, but not limited to, desired data delivery stream, receiving audience, user environment, Quality of Service (QoS), and network load. The classified content is then encrypted as an MPEG-2 data stream and passed to a splitter 37. The splitter 37 detects the priority assigned to the data by the classifier and passes the corresponding content to the appropriate LP or HP stream for transmission by the transmitter 11.

The receiver of each user, depending on its prevailing C/N ratio, is then able to receive either the HP stream alone or the HP and LP stream. In FIG. 3, and the chain line C/Nₘᵢₙ represents the maximum range from the transmitter 11 at which the C/N ratio allow satisfactory reception of the LP stream.

In the above example, the request R_{C}′ from the user of the mobile terminal for a web page is acted upon as follows. The request R_{C}′ reaches the SMS 29 via the return channel 23′ over the PLMN/PSTN 27. The SMS 29 notes that the request R_{C}′ identifies a particular user which it identifies from a subscriber list as having a mobile terminal 3′. The request R_{C}′ is passed to the Internet gateway 17 which obtains the content C′ and returns it to the SMS 29 whereupon data identifying the terminal 3′ is attached before passing the content C′ to the data classifier 35. The data classifier 35 obtains a user profile (A on FIG. 4) from the SMS 29 corresponding to the data identifying the terminal 3′. This profile is then used to assign a priority to the elements of the content C′. In this case the content C′ comprises textual elements and graphical elements which are identified by the classifier by reference to their file extensions. The classifier then looks up the appropriate priority on the user profile and adds this information to the content C′ which already contains data identifying the source of the request, namely the user of the mobile terminal 3′. This data is then encoded and placed into data containers before being passed to the splitter 22 which identifies from the containers the priority assigned to their contents and passes them to the appropriate stream 24,26 for transmission by the transmitter 11.

The mobile terminal 3′, which in this example is travelling in area relatively far from the transmitter, receives the transmission. Firstly, the conditional access component of the terminal 3′ identifies the transmission as being intended for it by reference to the address information added by the SMS 29. However, because of the relatively poor C/N ratio, the receiver is capable of decoding the HP stream 26 only. However, the lower bit rate of the HP stream means that the terminal 3′ is able to extract the textual and graphical data reliably. Therefore, there is a reduced need to request re-transmission of dropped or lost packets over the return channel. Once the data has been extracted, the content is amalgamated by the terminal 3′ and provided to the user via the display 7.

Turning to the user with a fixed terminal 3, the request R_{C}, which may be for the same or a different web page, is passed via the return channel 23 over the PLMN/PSTN 27. The SMS 29 notes that the request R_{C} identifies a particular user which it identifies from a subscriber list as having a fixed terminal 3. The request R_{C} is passed to the Internet gateway 17 which obtains the content C and returns it to the SMS 29 whereupon data identifying the terminal 3 is attached before passing the content C to the data classifier 35.

The data classifier 35 obtains a user profile (B on FIG. 4) from the SMS 29 corresponding to the data identifying the terminal 3. This profile is then used to assign a priority to the elements of the content C. In this case the content C comprises textual elements and graphical elements which are identified by the classifier by reference to their file extensions. The classifier 35 then looks up the appropriate priority on the user profile and adds this information to the content C which already contains data identifying the source of the request, namely the user of the mobile terminal 3. This data is then encoded and placed into data containers before being passed to the splitter 22 which identifies from the containers the priority assigned to their contents and passes them to the appropriate stream 24,26 for transmission by the transmitter 11.

The fixed user, who in this example is located relatively close to the transmitter, receives the transmission and through the conditional access mechanism identifies the transmission as being directed to it. Because of the good C/N ratio, the receiver is capable of decoding both HP and LP streams. Thus, the terminal is able to extract the textual and graphical data reliably at a faster overall rate than that achieved by the mobile user. As described above in relation to the mobile terminal 3′, the content is provided to the user on the display 7.

It will be recognised from the above that the ability to define the stream on which data is to be transmitted in a flexible and dynamic manner allows the network to be used to deliver data to users in a manner which seeks to maximise network resources. In the above examples, the user profile A set up for the user of the mobile terminal 3′ assigns the High Priority stream to text, graphics, data file and email content but not to video content. In practice, this means that the user of the mobile terminal can only receive video content when the C/N ratio is good enough to permit reception of the Low Priority Stream. Although video content could be placed in the High Priority Stream the lower bit rate might not meet the users requirements in terms of cost and speed.

Turning to the user profile B this places the text and email content into the High Priority Stream and the graphics, data file and video in to the Low Priority Stream. Such a configuration ensures particularly reliable delivery of text and email content whilst allowing the fastest possible transfer of the other content.

Other user profiles could be set up to suit the preferences of the user and/or the network. Indeed a facility could be provided to define an overriding set of priorities which could be employed at times of high network load, for example. Indeed, further more complex approaches to data classification for transmission on different streams are possible. Thus an operator of the network can set an interservice categorisation that places a complete service into a particular or indeed both streams, whilst a intraservice categorisation may be defined that allows critical data to be placed in the HP stream and non-critical data in the LP stream. The particular classification scheme used by the network operator may be driven by a number of factors including financial in the sense that an operator might offer those users prepared to pay for the facility the option of more reliable delivery and/or at faster rates in different circumstances e.g. time of the week/day.

It will be further appreciated that although the above examples refer to the presence of a return channel to assist in the selection of content, the process of data classification according to a preferred priority stream can be applied to any data which is intended to be transmitted by the network as a broadcast, multicast, or unicast, irrespective of whether the content has been requested by the user or not. Furthermore, although the above embodiment relates to DVB-T, the invention is, of course, applicable to any hierarchical network, in which the transmission capability exists on two or more levels which are ranked in accordance with a particular feature/criterion or perhaps features/criteria. Such a network might have a hierarchy based on one or more of the following attributes namely quality of service, delivery speed, error rate and such like.

What is claimed is:

1. A head end device for use in a hierarchical network, the device comprising a classifier connectable to a source of content and operable to place the content into at least one of a plurality of hierarchical data streams corresponding to a particular class of content.

2. A device as claimed in claim 1, wherein the classification of content is made in accordance with its data type.

3. A device as claimed in claim 2, wherein the classifier is connectable to a data stream of content in the form of data elements and a splitter connected to the output of the classifier wherein the classifier identifies the data type of each element of the stream and inserts a marker into said stream indicative of a priority assigned to the element such that splitter subsequently places each data element, in accordance with the marker, into a corresponding hierarchical transport stream for subsequent transmission by the network.

4. A device as claimed in claim 2 or claim 3, further including a connection to a look-up table accessible in use by said classifier, the table comprising a set of profiles, each of which includes at least one definition of a priority for a particular data type wherein the selection by the classifier of a particular profile for identifying the data type of each element is determined by the network.

5. A device as claimed in any preceding claim, wherein said hierarchical data streams are ranked in accordance with a predetermined criterion.

6. A method of transmitting content in a hierarchical network comprising classifying content received for transmission and placing the content into at least one of a plurality of hierarchical data streams corresponding to the classification of the content.

7. A method as claimed in claim 6, including defining a data stream for a particular classification.

8. A method as claimed in claim 7, including establishing a set of profiles, each of which includes at least one definition of a data stream for a particular classification wherein the selection of a particular profile is determined by the network.

9. A method as claimed in claim 8, wherein the network determines the selection of a profile on the basis of an intended recipient of the content.

10. A method as claimed in claim 8, wherein the network determines the selection of a profile on the basis of a service providing said content.

11. A method as claimed in claim 8, wherein the network determines the selection of a profile on the basis of network load.

12. A method as claimed in any one of claims 6 to 11, wherein said hierarchical data streams are ranked in accordance with a predetermined criterion.

13. A method as claimed in any one of claims 7 to 10, wherein the network is a terrestrial digital video broadcast network (DVB-T).

14. A computer program comprising executable code for execution when loaded on a computer, wherein the computer is operable in accordance with said code to carry out the method according to any one of claims 6 to 13.

15. A program as claimed in claim 14, stored on a computer readable medium.

16. A system for delivering content over a hierarchical network, comprising a source of content deliverable, to a network, the network including head end equipment operable to place content into at least one of a plurality of selected hierarchical data streams for transmission by a transmitter, and a terminal operable to receive the data stream, wherein the head-end equipment classifies the content and in accordance with the classification places it into a corresponding hierarchical data stream.

17. A system as claimed in claim 16, wherein the terminal provides a return channel connectable, in use, to the network, such that a request for the delivery of content may be originated by the terminal.

18. A system as claimed in claim 16 or claim 17, wherein said hierarchical data streams are ranked in accordance with a predetermined criteria.

19. A method of delivery content to a terminal in a network having a plurality of hierarchical data streams, the method comprising receiving a request for content, passing said request to a network gateway and subsequently receiving content identified in said request in the form of at least one content element, classifying said at least one content element, assigning a priority to said at least one content element in accordance with said classification and assigning said content element to a hierarchical data stream appropriate to said priority.

20. A method as claimed in claim 19, wherein a user identity is identified from said request and a corresponding user profile obtained in accordance with which profile priority is assigned to said at least one content element.

21. A method as claimed in claim 19 or claim 20, wherein said request is received in a return channel established by a terminal of a public land mobile network via a public switched telephone network and said content element is delivered over a broadband broadcast network.

22. A method as claimed in any one of claims 19 to 21, wherein said hierarchical data streams are ranked in accordance with a predetermined criteria.

23. A computer program comprising executable code for execution when loaded on a computer, wherein the computer is operable in accordance with said code to carry out the method according to any one of claims 19 to 22.

24. A program as claimed in claim 23, stored on a computer readable medium.
